(19) United States
(12) Patent Application Publication
(10) Pub. No.: US 2026/0249505 A1
(43) Pub. Date: Aug. 27, 2026

(54) CUTTING DEVICE FOR MAKING A CUT-OUT IN A WALL OF A BOX

(71) Applicant: Exotec Product France, Croix (FR)

(72) Inventor: Jean-Marie Ridez, Wimereux (FR)

(73) Assignee: Exotec Product France, Croix (FR)

(21) Appl. No.: 18/872,493

(22) PCT Filed: Jun. 7, 2023
(86) PCT No.: PCT/EP2023/065196

§ 371 Date: Dec. 6, 2024

(30) Foreign Application Priority Data
Jun. 7, 2022 (FR) FR2205429

(51) Int. Cl. B26D 7/26; B25J 11/00; B26D 1/00; B26D 5/00; B26D 5/06; B26D 7/06

(52) U.S. Cl. CPC B26D 7/2628; B25J 11/0055; B26D 1/0006; B26D 5/007; B26D 5/06; B26D 7/0625; B26D 2001/006

(57) ABSTRACT

The invention relates to a cutting device (200) for performing a cut in a wall of a box (100) including: a first part (210) comprising the cutting member and a first support element (212); a second part (222) including a footpad (224) movable in translation relative to the blade along the longitudinal axis (A); wherein said cutting device has at least one first and one second cutting positions corresponding to at least two cutting depths of the wall, the blade protruding axially beyond the footpad when the cutting device is in its first or second cutting positions, wherein the cutting device further includes a selection device (260) for selecting the first cutting position or the second cutting position.

### TECHNICAL FIELD

The present disclosure relates to the field of opening boxes, particularly cardboard packing boxes. It relates in particular to a cutting device for performing a cut in a wall of a box, as well as an installation for opening boxes including a cutting device of this type. An installation of this type is most often used in logistical or distribution centers for opening cardboard boxes containing articles at a fast pace.

### PRIOR ART

In the past, cardboard boxes were opened manually in order to extract from them the articles and products transported. This manual work being time-consuming, sometimes dangerous and likely to damage the products contained in the boxes, logistical centers have gradually equipped themselves with installations for opening boxes automatically.

These opening installation implement a cutting step in which a cutting tool, generally comprising a blade, performs continuous cutting or precutting in the box.

The cutting device is generally attached to a multi-axis robotic head.

Moreover, it is frequent that the boxes received at the entrance of the installation have different wall thicknesses. The cutting depth of the cutting tools is general dimensioned for a median wall thickness.

In the case where the wall to be cut of one of the boxes is greater than this median thickness, it can happen that the cutting depth is not sufficient to allow a clean opening of the wall. Manual intervention is then necessary to finalize the opening of the boxes, which impairs the effectiveness of the opening method.

### DISCLOSURE OF THE INVENTION

One object of the disclosure is to propose a cutting device correcting the aforementioned disadvantages and being able to adapt itself to different wall thicknesses.

The invention achieves this object by a cutting device for performing a cut in a wall of a box, said cutting device extending along a longitudinal axis between a mounting part for a robotic head and a cutting member provided with a blade, the blade having at least one first cutting edge, the cutting device including:
a first part comprising the cutting member and a first support element;
a second part, movable in translation relative to the first part along the longitudinal axis, the second part including a footpad having a bearing surface, so that the footpad is movable in translation relative to the blade along the longitudinal axis;
in which said cutting device has at least one first and one second cutting positions corresponding to at least two different cutting depths of the wall, the blade protruding axially beyond the footpad when the cutting device is in its first or second cutting position,
in which, in the first cutting position, the footpad is at a first axial distance from the first support element, so that the blade extends beyond the footpad over a first length corresponding to a first cutting depth, and in which, in the second cutting position, the footpad is at a second axial distance from the first support element so that the blade extends beyond the bearing surface over a second length corresponding to a second cutting depth, the first cutting depth being greater than the second cutting depth,
in which the cutting device further includes a selection device for selecting the first cutting position or the second cutting position.

It is understood that the first length is greater than the second length. The cutting device according to the disclosure therefore offers at least two cutting depths. The first cutting depth is a great cutting depth, for example on the order of 7 mm, while the second cutting depth is a smaller cutting depth, for example on the order of 4 mm.

The selection device allows determining the minimum axial distance between the footpad and the first support element among the first and second axial distances, so as to select the cutting depth among the first and second cutting depths.

It is understood that the cutting depth corresponds at most to the length of the portion of the blade that protrudes beyond the bearing surface of the footpad.

The cutting device according to the disclosure is adapted easily and rapidly to the thickness of the wall to be cut, which allows producing qualitative cuts, for walls of different thicknesses, without having to stop the installation or to provide several cutting devices.

The modification of the cutting depth is therefore accomplished via the selection device, which can be done manually or automatically.

In the latter case, the controller of the cutting installation can for example receive a control signal representing the thickness of the walls of the boxes entering the installation, and control the selection device to select the cutting depth suitable for said thickness.

It is understood that the modification of the depth can occur rapidly, for example immediately after having completed the cutting of the wall of a first box, and before cutting the wall of the following box having a different thickness.

The cutting device according to the invention therefore has the advantage of being able to adapt rapidly to the wall thickness of the box entering the box cutting and opening installation.

It is understood, moreover, that the modification of the cutting depth is accomplished by adjusting the length of the blade portion that protrudes axially beyond the footpad when said footpad is bearing against the wall to be cut.

More precisely, the selection device has as its function to limit the length of the blade portion that protrudes axially beyond the bearing surface of the footpad.

In operation, the cutting device is moved toward the box to that the bearing surface of the footpad bears against the wall to be cut. A slight pressure directed downward is applied to the cutting device so that the first part approaches the second part (which is bearing against the wall to be cut), following which the blade penetrates into the wall to be cut to a depth corresponding to the first or to the second cutting depth. The cutting depth, defined as being the maximum distance between the lower end of the blade and the bearing surface, then corresponds to the minimum distance between the footpad and the first support element of the first part.

This minimum distance between the footpad and the first support element is preferably attained, during use, due to one or more end-of-stroke stops limiting the axial movement of the second part relative to the first part.

Without departing from the scope of the present invention, the cutting device could have more cutting positions.

Advantageously, the selection device includes an end-of-stroke stop element which is retractable and which has a deployed position in which the second part is bearing against the end-of-stroke stop element when the cutting device is in the second cutting position, and a retracted position in which the end-of-stroke stop element does not limit the axial movement of the second part relative to the first part.

It is understood that, when the stop element is in the retracted position, the axial travel of the first part relative to the second part is greater that it is when the stop element is in the deployed position. Thus, when the stop element is in the retracted position, the maximum distance between the lower end of the blade and the bearing surface is greater than what it is when the end-of-stroke stop element is in the deployed position and that the second part is in contact against the stop element, which occurs when the bearing surface is bearing on the wall to be cut.

The end-of-stroke stop element thus allows defining the second cutting depth.

Preferably, the first part further includes an actuator for moving the end-of-stroke stop element between its retracted position and its deployed position.

This actuator is for example a pneumatic jack.

Still preferably, the actuator is configured to move the stop element in a movement direction which is transverse to the longitudinal axis. Preferably, the movement direction is orthogonal to the longitudinal axis.

Advantageously, the actuator is attached to a second support element of the first part, the second support element being located at a distance above the first support element.

Preferably, the first support element is connected to the second support element by means of at least one spacer.

Preferably, the end-of-stroke stop element is located between the first support element and the second support element.

Optionally, the first part further includes a load absorption element located axially above the end-of-stroke stop element and, in the deployed position, the end-of-stroke stop element is in contact with the load absorption element.

The load absorption element is for example a metal plate integral with the second support element.

It is understood that the load absorption element allows preventing damage to the second support element which the second part comes into abutment against the end-of-stroke stop element.

Advantageously, the second part further comprises at least one first arm integral with the footpad and mounted sliding relative to the first support element along the longitudinal axis, the first arm crossing the first support element, the second part further comprising a contact element, connected to the first arm and in which the contact element is bearing against the end-of-stroke stop element when the cutting device is in the second cutting position.

It is understood that the contact element is arranged to bear on the end-of-stroke stop element when the latter is in the deployed position.

Conversely, when the end-of-stroke stop element is in the retracted position, the contact element does not cooperate with the end-of-stroke stop element so that the movement of the contact element is not limited by the end-of-stroke stop element.

Preferably, the first support element includes a first guide sleeve in which the first arm slides.

Preferably, the second part further includes a second arm mounted sliding relative to the first support element and integral with the footpad, the second arm crossing the first support element, the first and second arms being located on either side of the cutting member and the contact element constituting an element connecting the first and second arms together. It is understood that the connection element is arranged to come into abutment against the end-of-stroke stop element when the cutting device is in the second cutting position. Advantageously the first part further includes an end-of-stroke stop member arranged to stop the stroke of the footpad in the first position of the cutting device when the end-of-stroke stop element is in the retracted position and, considered in the longitudinal axis, the end-of-stroke stop element is located between the end-of-stroke stop member and the footpad.

Preferably, the end-of-stroke stop member is attached to the second support element. The axial extension of the end-of-stroke stop member can be adjusted manually, for example by screwing, in order to adjust the first cutting depth. Advantageously to facilitate the movement of the footpad on the wall to be cut while providing pressure against the wall to be cut, the footpad further includes at least one first supporting roller to bear against the wall of the box. The first supporting roller is mounted in rotation on a shaft which is engaged in the footpad.

Preferably, the footpad includes a second supporting roller, the first and second supporting rollers being located on either side of the blade.

Advantageously, the blade further includes a second cutting edge which is opposite to the first cutting edge, and the blade preferably has a pointed shape.

The blade preferably extends in a plane which is orthogonal to the axis of the first supporting roller.

Advantageously, the first part is movable in translation relative to the mounting part along the longitudinal axis, and the mounting part is connected to the first part by means of a spring member.

This flexible mounting allows following the possible variations of height of the box.

Preferably, the second support element and the mounting part are mounted to one another by means of members for guiding in translation which extend parallel to the longitudinal axis, by being preferably positioned on either side of the spring member.

Advantageously, the cutting member further includes a blade holder provided with controllable jaws, the blade being held by the controllable jaws.

The controllable jaws can be actuated in opening and/or in closing by a pneumatic jack.

The movement direction of the controllable jaws is preferably perpendicular to the face of the blade.

To ensure the presence of a new blade in a replacement blade magazine of the installation, the first part further includes a blade presence sensor. The blade presence sensor is preferably mounted in the first support element. When the cutting device is brought above the magazine, the blade presence detector detects whether a replacement blade is actually present in the magazine.

Advantageously, considered in a plane perpendicular to the longitudinal axis, the footpad has a “U” shaped portion in which the cutting member is engaged, the “U” shaped portion being open laterally.

Preferably, the lateral edges of the “U” shaped portion are attached to the first and second arms. This opening allows easier access to the blade to facilitate maintenance.

Still preferably, the blade presence sensor is mounted next to the first support element, and the “U” shaped portion is open laterally toward the blade presence sensor.

This arrangement allows improving the detection of the presence of the blade in the blade magazine.

The invention further relates to an installation for opening boxes, comprising at least:
one conveyor for moving the boxes in a direction of travel,
one cutting robot provided with a cutting device according to the disclosure, the cutting robot having a head attached to the mounting head of the cutting device.

The installation further includes a controller arranged to control the selection device, preferably but not exclusively based on a control signal representing the thickness of the box walls.

Advantageously, the installation further includes a cutting station including the cutting robot, and a box opening station including a gripping robot with suction cups for opening the cut walls, the box opening station being positioned downstream of the cutting station.

Preferably, the installation further comprises a replacement blade magazine. This magazine contains new blades and preferably supports for receiving the worn blades.

### DESCRIPTION OF THE DRAWINGS

The disclosure will be better understood upon reading the description that follows, of an embodiment of the disclosure given by way of a non-limiting example, with reference to the appended drawings, in which:

FIG. 1 is a perspective view of an installation for opening cardboard boxes comprising a cutting device according to the disclosure;

FIG. 2 is a front view in perspective of the cutting device according to the disclosure, in the first cutting position;

FIG. 3 is a rear view in perspective of the cutting device of FIG. 2;

FIG. 4 is a front view in perspective of the cutting device according to the disclosure, in the second cutting position;

FIG. 5 is a rear view in perspective of the cutting device of FIG. 4;

FIG. 6 is a detail view of FIG. 2 showing the end-of-stroke stop element in the retracted position;

FIG. 7 is a detail view of FIG. 3 showing the end-of-stroke stop element in the deployed position;

FIG. 8 is a side view of the device of FIG. 6 showing the blade in the first cutting position; and

FIG. 9 is a side view of the device of FIG. 7 showing the blade in the second cutting position.

### DETAILED DESCRIPTION

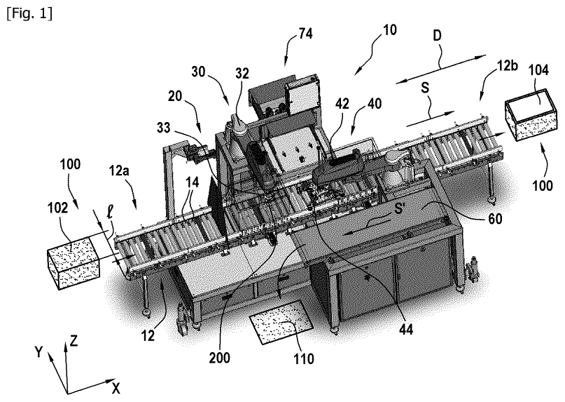

An installation 10 for opening boxes has been illustrated in FIG. 1, particularly cardboard boxes containing articles. In this example, the boxes 100 are cardboard, having a well known generally parallelepiped shape, and which are traditionally used for transporting articles. The installation 10 has as its function automatically opening such boxes, and more precisely an upper wall 102 of the box. The installation 10 receives the boxes 100 at its entrance and supplies at its exit a box, the upper wall 102 of which has an opening 104.

The installation 10 has a main conveyor 12, in this example a roller conveyor 14, which extends in a longitudinal direction D and which has a direction of travel S between an upstream part 12a and a downstream part 12b of the main conveyor 12.

In this FIG. 1, a reference frame XYZ is shown. The longitudinal direction D is parallel to the axis x, the width of the main conveyor extends along the axis Y, and the axis Z is vertical.

In the description that follows, the terms upstream and downstream will be considered with reference to the direction of travel S.

In this example, considered in the direction of travel S, from upstream to downstream, the installation 10 according to the exemplary embodiment includes successively a measurement station 20, a cutting station 30 and a discharge station 40.

It is understood that the box is initially deposited at the upstream part 12a of the main conveyor 12, i.e. upstream of the measurement station 20. The open box then leaves by the downstream part 12b of the discharge station 40.

Located downstream of the measurement station 20, the cutting station 30 includes a cutting robot 32 provided with a cutting device 200 which will be described in more detail below. The cutting robot 32 is, in this example, a multi-axis robot which allows the cutting device 200 to be moved in space along the axes X, Y and Z. As will be explained below, the cutting device 200 includes two cutting depths in order to adapt itself to the thickness of the upper wall 102 to be cut. It is specified that, in this example, the information relating to the upper wall to be cut is transmitted to a controller of the installation via a control signal.

The discharge station 40, located downstream of the cutting station 30, includes a gripping robot 42, similar in this example to the cutting robot. The gripping 42 is provided with a gripping device 44. In this example, the gripping device 44 includes suction members appearing in the form of suction cups.

According to the disclosure, the gripping device 44 seizes the wall part 110 that has been cut by the cutting device 100, and the gripping device is moved in order to detach the wall part from the body of the box. The cut part is then placed on a secondary conveyor 60 which extends parallel to the main conveyor while having, in this non-limiting example, a direction of travel S′ opposite to the direction of travel S of the main conveyor 12.

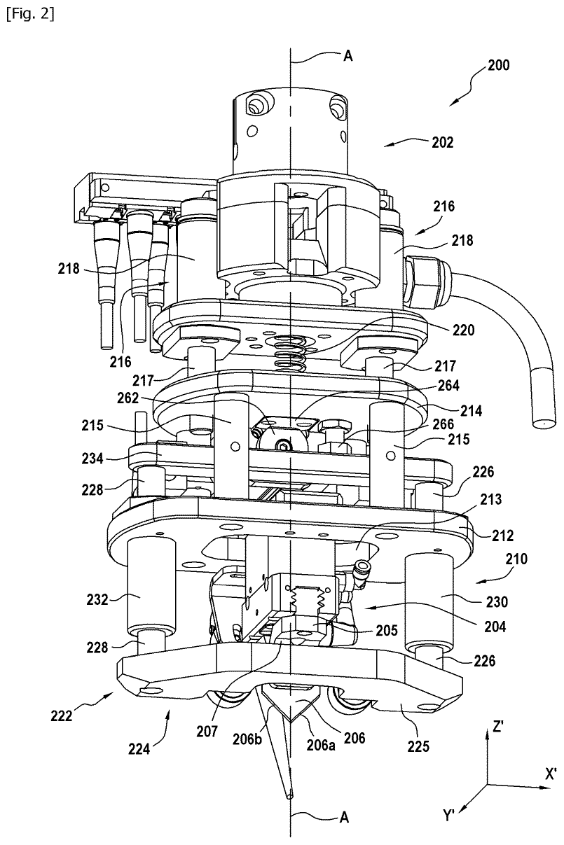

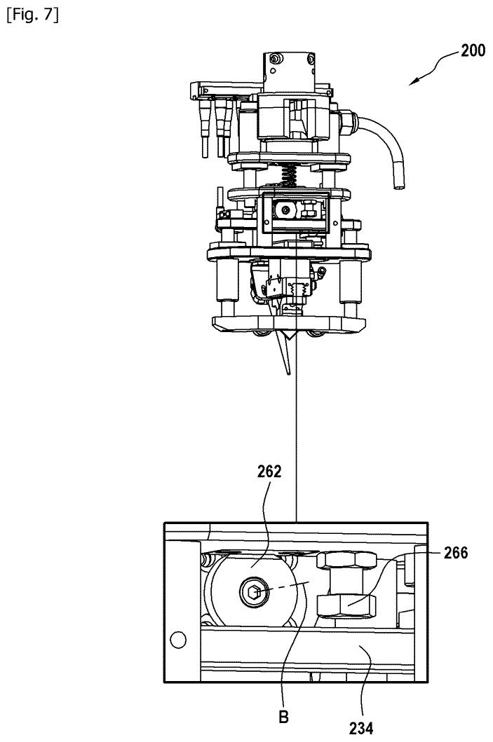

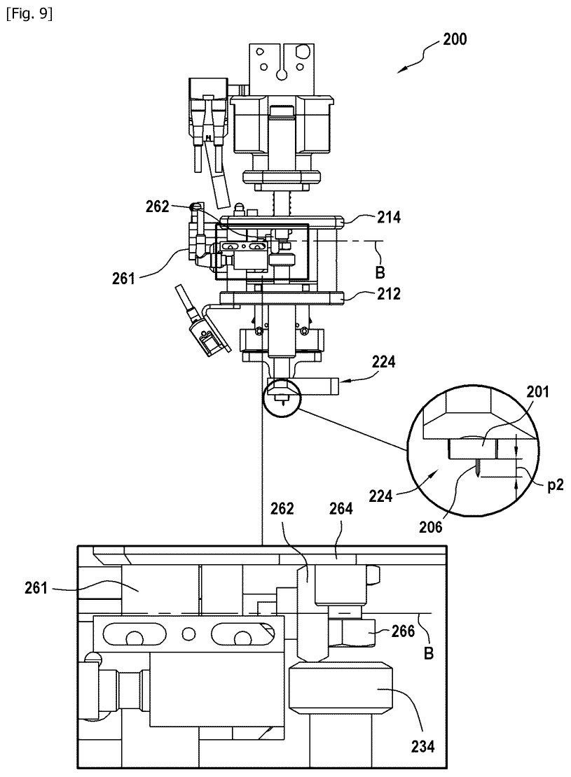

A cutting device 200 will be described, according to a first exemplary embodiment, by means of FIGS. 2 to 9.

Shown is a frame of reference X′Y′Z′, the axis Z′ of which is parallel to the longitudinal axis A of the cutting device.

As indicated above, the cutting device 200 has as its function to perform a cut in an upper wall of a box 100. The cutting device 200 extends along a longitudinal axis A between a mounting part 202, intended to be mounted to a head 33 of the cutting robot 32, and a cutting member 204 which is provided with a blade 206.

The blade 206 includes a first cutting edge 206a which defines a cutting direction along an axis X′ perpendicular to the axis Z′.

The axis X′ is oriented in the direction defined by the first cutting edge 206a while the axis Y′ is orthogonal to the axes X′ and Z′.

In this example, the blade 206 has a pointed shape and further includes a second cutting edge 206b which is opposite to the first cutting edge 206a.

The cutting device 200 comprises a first pate 210 comprising the cutting member 204 and a first support element 212. In this example, the cutting member 204 is attached to the first support element 212.

The cutting member 204 further includes a blade holder 205 which is provided with controllable jaws 207. The blade 206 is held by the controllable jaws 207 of the blade holder. The opening of the controllable jaws 207 to release the blade is controllable by the controller of the installation.

In this example, the first support element 212 appears in the form of a plate having a central opening 213 in which the cutting member 204 is engaged, while being attached to an upper face of the first support element 212.

The first part 210 further includes a second support element 214, which is located at a distance above the first support element 212 by means of spacers 215. In this example, the spacers 215 take the form of bars extending parallel to the longitudinal axis A.

Moreover, in this example, the first part 210 is movable in translation relative to the mounting part 202 along the longitudinal axis A. To this end, the first part 210 and the mounting part 202 comprise first and second members 216 for guiding in translation which include shanks 217 attached to the second support element 214 and engaged in the sheaths 218 belonging to the mounting part 202. It is specified that the shanks 217 are free to move in translation in the sheaths 218 in translation parallel to the axis Z′.

In addition, the mounting part 202 is connected to the first part, and more precisely in this example to the second support element 214 by means of a spring member 220 which is located between the shanks 217. In this example, the spring member is a compression spring which extends along the axis Z′. The spring member has as its function to absorb the movements of the footpad along the axis Z′ due to possible height variations of the box. It is therefore understood that the blade 206 is movable relative to the mounting part 202 along the longitudinal axis A via the spring member 220.

The cutting device 200 further includes a second part 222, which is movable in translation relative to the first part 210 along the longitudinal axis A. The second part 222 includes a footpad 224 having a lower face 225. The footpad is formed to bear against the wall of the box to be cut. It is therefore understood that the footpad 224 is movable in translation relative to the blade 206 along the longitudinal axis A. To this end, the second part 222 comprises a first arm 226 and a second arm 228 which are integral with the footpad 224, the first and second arms 226, 228 are mounted sliding relative to the first support element 212 parallel to the longitudinal axis A. It is noted that the first and second arms 226, 228 are engaged in guide sleeves 230, 232 which are attached to the first support element 212. It is noted moreover that the first and second arms 226, 228 are located on either side of the cutting member 204. As noted particularly in FIG. 2, the first and second arms 226, 228 cross the first support element 212 so as to protrude above said first support element 212. The first and second arms 226, 228 are connected together by a connection element 234 which is therefore located between the first support element 212 and the second support element 214. In this example, the connection element 234 forms a bar which extends along the axis X′.

The spring member 220 has as its function to absorb movements along the axis Z′ due to possible height variations of the box.

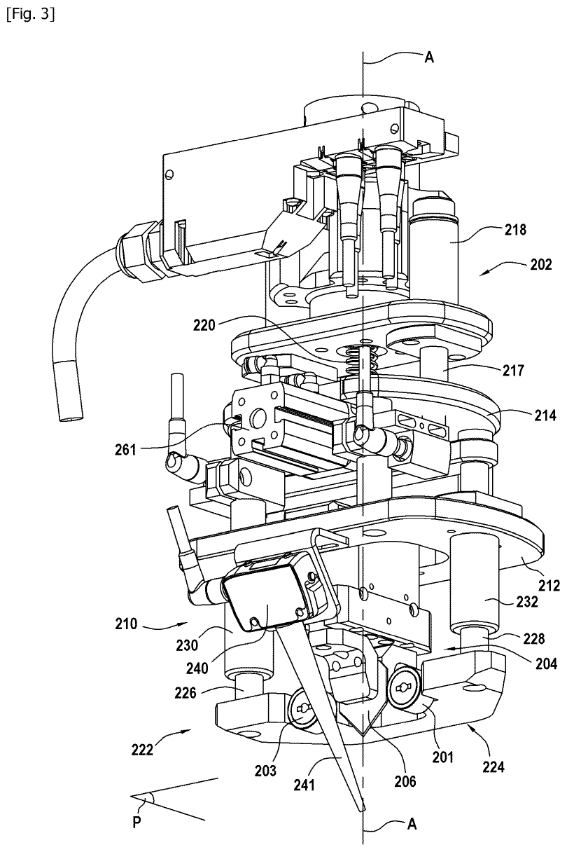

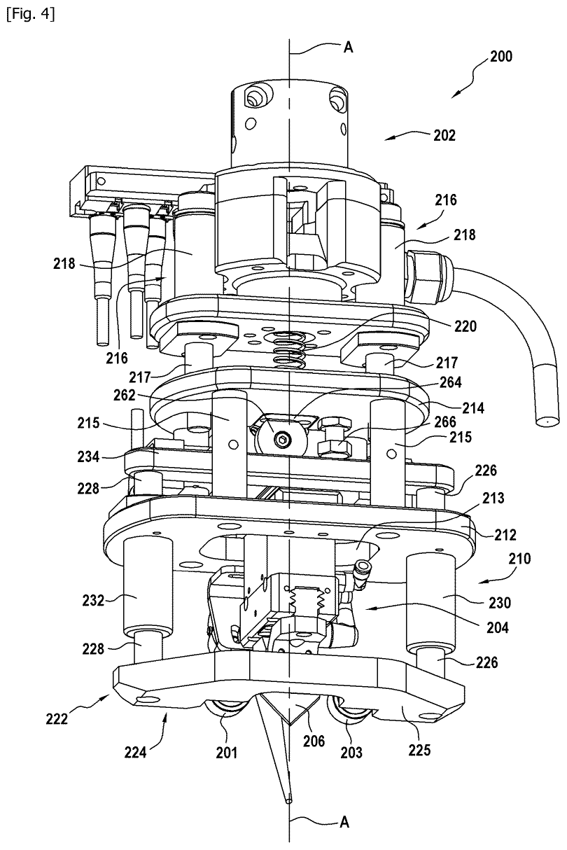

Referring to FIGS. 3 and 4, it is noted that the first part 210 further includes a blade presence sensor 240 which is attached to the first support element 212. In the figures, the beam 241 of the blade presence sensor 240 has been illustrated schematically. The function of the blade presence sensor 240 is to be certain of the presence of a replacement blade in a replacement blade magazine 74 of the installation.

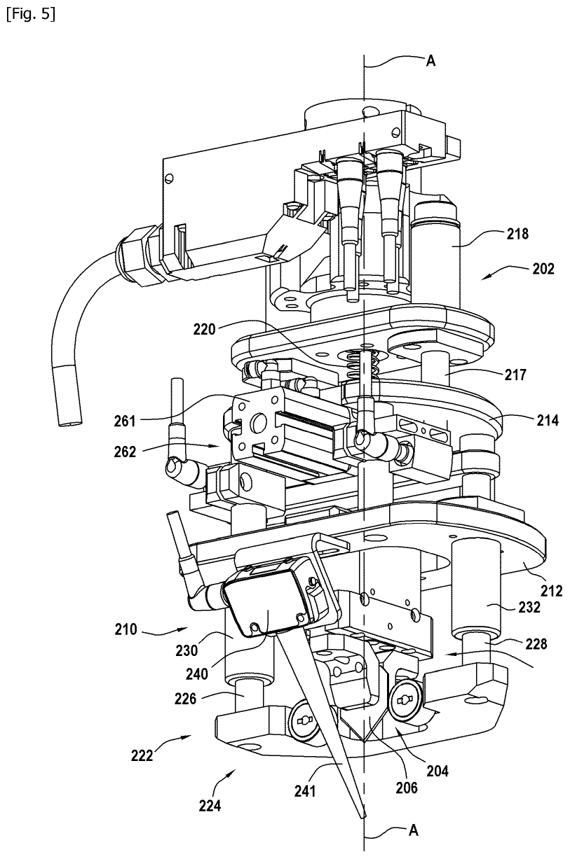

Referring to FIGS. 3 and 5, it is noted that, considered in a plane P perpendicular to the longitudinal axis A, the footpad 224 has a “U” shaped portion in which the cutting member 204 is engaged, the “U” shaped portion being open laterally toward the blade presence sensor 240.

Moreover, the footpad 224 further includes a first support roller 201 and a second support roller 203 which are located on either side of the blade 206, the first and second rollers 201, 203 being arranged to bear against the wall of the box to be cut during the cutting operation. They also serve to facilitate the movement of the footpad during the cutting operation. Without departing from the scope of the present invention, the support rollers could be replaced by bosses of the footpad 224.

According to the disclosure, the cutting device 200 has at least one first and one second cutting positions corresponding to at least two different cutting depths of the wall, the blade 206 protruding axially beyond the footpad when the cutting device is in its first or second cutting positions. In this example, the blade 206 protrudes axially beyond the first and second support rollers.

The bearing surface is, in this example constituted by the peripheral faces of the first and second support rollers.

In FIGS. 2 and 3, the cutting device has been illustrated in its first cutting position, the cutting depth being on the order of 7 mm, while in FIGS. 3 and 5 the cutting device 200 has been illustrated in its second cutting position, the second cutting depth being on the order of 4 mm.

In the first cutting position, illustrated in FIGS. 2, 4, 6 and 8, the footpad 224 is at a first axial distance d1 from the first support element 212, so that the blade 206 extends along the axis Z′ beyond the footpad 224—in this example beyond the first support roller 201—over a first length corresponding to a first cutting depth p1.

Moreover, in the second cutting position illustrated in FIGS. 3, 5, 7 and 9, the footpad 224 is at a second axial distance d2 from the first support element 212, so that the blade 206 extends laterally beyond the footpad—in this example beyond the first support roller 201—over a second length corresponding to a second cutting depth p2. It is understood by means of the figures that the first cutting depth p1 is greater than the second cutting depth p2.

The cutting device 200 also includes a selection device 260 for selecting the first cutting position or the second cutting position. To this end, in this example, the selection device 260 includes an end-of-stroke stop element 262 which is retractable.

The end-of-stroke stop element 262 has a deployed position illustrated in FIGS. 3, 5, 7 and 9 in which the second part bears against the end-of-stroke stop element 262 when the cutting device is in the second cutting position. More precisely, the connection element 234 forms a contact element which comes against the end-of-stroke stop element 262 when the cutting device is in the second cutting position.

As explained above, the first part is movable relative to the second part so that when the supporting roller 201, 203 bears against the wall to be cut, the second part then moves axially toward the mounting part until the connection element 234 bears against the end-of-stroke stop element 262, thus defining the second cutting depth. In this example, the end-of-stroke stop element 262 has the general shape of a disk, including a lower flat and an upper flat, the lower flat forming an end-of-stroke stop for the connection element 234 while the upper flat bears against the second supporting element 214.

To avoid damaging the second support element 214, the first part also includes a load absorption element 264 which is located axially above the end-of-stroke stop element. The load absorption element is a steel part housed in the second support element 214. It is understood that, in the deployed position, the end-of-stroke stop element is in contact with the load absorption element 264, so that the impacts of the connection element 234 on the end-of-stroke stop element 262 are absorbed by the load absorption element 264.

Moreover, the end-of-stroke stop element 262 includes a retracted position illustrated in FIGS. 2, 4, 6 and 8 in which the end-of-stroke stop element does not limit the axial movement of the second part relative to the first part. In other words, in the retracted position, the end-of-stroke stop element 262 does not cooperate with the connection element 234.

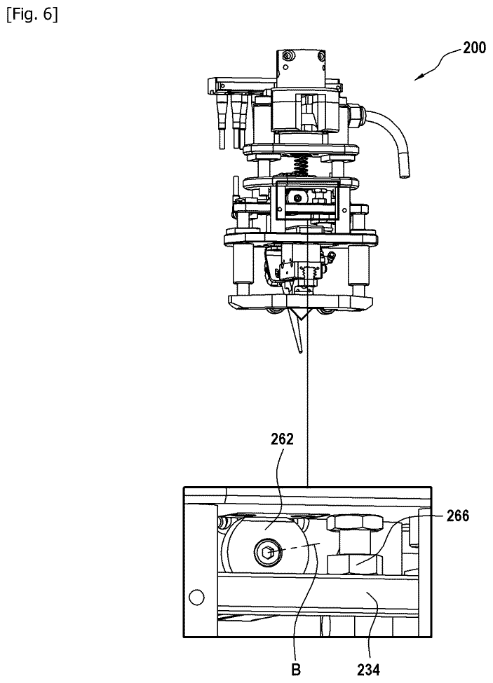

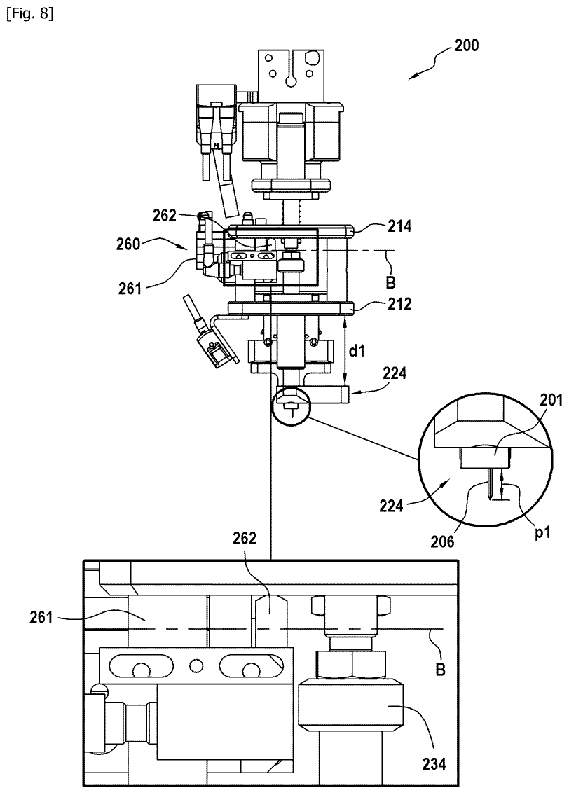

Thus the connection element 234 can move axially relative to the first part beyond the stop element. The first part also includes an end-of-stroke stop member 266 to stop the travel of the footpad 224 in the first cutting position when the end-of-stroke stop element 262 is in the retracted position. Referring to FIGS. 6 and 8, it is understood that the connection element 234 comes into abutment against the end-of-stroke stop member 266 when the cutting device is in its first cutting position.

It is noted in the figures that, considered in the longitudinal axis A, the end-of-stroke stop element 262 is located between the end-of-stroke stop member 266 and the footpad 224.

To move the end-of-stroke stop element 262 between its retracted position and its deployed position, the first part also includes an actuator 261 which appears in the form of a pneumatic jack allowing the end-of-stroke stop element to be moved in a movement direction B which is transverse to the longitudinal axis A.

1. A cutting device for performing a cut in a wall of a box, said cutting device extending along a longitudinal axis between a mounting part for a robotic head and a cutting member provided with a blade, the blade having at least one first cutting edge, the cutting device including:
a first part comprising the cutting member and a first support element;
a second part, movable in translation relative to the first part along the longitudinal axis, the second part including a footpad having a bearing surface, so that the footpad is movable in translation relative to the blade along the longitudinal axis;
wherein said cutting device has at least one first and one second cutting positions corresponding to at least two different positions for cutting the wall, the blade protruding axially beyond the footpad when the cutting device is in its first or second cutting position,
wherein, in the first cutting position, the footpad is at a first axial distance from the first supporting element, so that the blade extends beyond the footpad over a first length corresponding to a first cutting depth and wherein, in the second cutting position, the footpad is at a second axial distance from the first support element so that the blade extends beyond the bearing surface over a second length corresponding to a second cutting depth, the first cutting depth being greater than the second cutting depth, wherein the cutting device further includes a selecting device for selecting the first cutting position or the second cutting position.

2. The cutting device according to claim 1, wherein the selection device includes an end-of-stroke stop element which is retractable and which has a deployed position in which the second part is supported against the end-of-stroke stop element when the cutting device is in the second cutting position, and a retracted position in which the end-of-stroke stop element does not limit the axial movement of the second part relative to the first part.

3. The cutting device according to claim 2, wherein the first part further includes an actuator for moving the end-of-stroke stop element between its retracted position and its deployed position.

4. The cutting device according to claim 3, wherein the actuator is configured to move the stop element in a movement direction which is transverse to the longitudinal axis.

5. The cutting device according to claim 3, wherein the actuator is attached to a second support element of the first part, the second support element being located at a distance above the first support element.

6. The cutting device according to claim 2, wherein the first part further includes a load absorption element located axially above the end-of-stroke stop element and wherein, in the deployed position, the end-of-stroke stop element is in contact with the load absorption element.

7. A The cutting device according to claim 2, wherein the second part further comprises at least one first arm integral with the footpad and mounted sliding relative the first support element along the longitudinal axis, the first arm crossing the first support element, the second part further comprising a contact element, connected to the first arm and wherein the contact element is bearing against the end-of-stroke stop element when the cutting device is in the second cutting position.

8. The device according to claim 7, wherein the second part further includes a second arm mounted sliding relative to the first support element and integral with the footpad, the second arm crossing the first support element, the first and second arms being located on either side of the cutting member and the contact element constituting an element connecting the first and second arms together.

9. The cutting device according to claim 2, wherein the first part further includes an end-of-stroke stop member arranged to stop the stroke of the footpad in the first position of the cutting device when the end-of-stroke stop element is in the retracted position, and wherein, considered in the horizontal axis, the end-of-stroke stop element is located between the end-of-stroke stop member and the footpad.

10. The cutting device according to claim 1, wherein the footpad further includes at least one supporting roller to bear against the wall of the box.

11. The cutting device according to claim 1, wherein the blade further includes a second cutting edge which is opposite to the first cutting edge, and wherein the blade preferably has a pointed shape.

12. The cutting device according claim 1, wherein the first part is movable in translation relative to the mounting part along the longitudinal axis, and the mounting part is connected to the first part by means of a spring member.

13. The cutting device according to claim 1, wherein the cutting member further comprises a blade holder provided with controllable jaws, the blade being held by the controllable jaws.

14. The cutting device according to claim 1, wherein the first part further includes a blade presence sensor.

15. The cutting device according to claim 1, wherein, considered in a plane perpendicular to the longitudinal axis, the footpad has a “U”shaped portion, wherein the cutting member is engaged, the “U”shaped portion being open laterally.

16. The cutting device according to claim 14, wherein, considered in a plane perpendicular to the longitudinal axis, the footpad has a “U”shaped portion, wherein the cutting member is engaged, the “U”shaped portion being open laterally, wherein the blade presence sensor is mounted on a first support element, and wherein the “U”shaped portion is open laterally toward the blade presence sensor.

17. An installation for opening boxes, comprising at least:
a conveyor for moving the boxes in the installation in a direction of travel (S),
a cutting robot comprising a cutting device for performing a cut in a wall of a box, said cutting device extending along a longitudinal axis between a mounting part for a robotic head and a cutting member provided with a blade, the blade having at least one first cutting edge, the cutting device including:
a first part comprising the cutting member and a first support element;
a second part, movable in translation relative to the first part along the longitudinal axis, the second part including a footpad having a bearing surface, so that the footpad is movable in translation relative to the blade along the longitudinal axis;
wherein said cutting device has at least one first and one second cutting positions corresponding to at least two different positions for cutting the wall, the blade protruding axially beyond the footpad when the cutting device is in its first or second cutting position,
wherein, in the first cutting position, the footpad is at a first axial distance from the first supporting element, so that the blade extends beyond the footpad over a first length corresponding to a first cutting depth and wherein, in the second cutting position, the footpad is at a second axial distance from the first support element so that the blade extends beyond the bearing surface over a second length corresponding to a second cutting depth, the first cutting depth being greater than the second cutting depth, wherein the cutting device further includes a selecting device for selecting the first cutting position or the second cutting position;
and wherein said cutting robot a head attached to the mounting head of the cutting device.
